(19) United States
(12) Patent Application Publication
(10) Pub. No.: US 2021/0271011 A1
(43) Pub. Date: Sep. 2, 2021

(54) Preserving In-Plane Function of Polarization Laminates in a Forming Process

(71) Applicant: Gary Sharp Innovations, LLC, Boulder, CO (US)

(72) Inventors: David A. Coleman, Louisville, CO (US); Gary D. Sharp, Boulder, CO (US)

(21) Appl. No.: 17/189,118

(22) Filed: Mar. 1, 2021

Related U.S. Application Data
(60) Provisional application No. 62/983,635, filed on Feb. 29, 2020.

(51) Int. Cl. G02B 5/30; G02B 27/28; B29C 51/42; B29C 51/14

(52) U.S. Cl. CPC G02B 5/305; G02B 27/288; B29L 2011/0016; B29C 51/14; B29C 51/426

(57) ABSTRACT

Optical films that are thermo-formed to create a curved surface while maintaining a fixed magnitude and orientation of the local in-plane birefringence. While perhaps not practical to maintain the magnitude of the differences in index of refraction between three orthogonal axes in a material undergoing an arbitrary deformation, it is possible to maintain the difference between two of the indices under certain conditions. This enables the incorporation of functional retarder layers into curved structures such as lenses and reflective polarizer films. Furthermore, it enables the minimization of retardation induced in the surrounding initially isotropic substrates.

### CROSS-REFERENCE

This application claims priority to U.S. Provisional Application No. 62/983,635 filed Feb. 29, 2020, the contents of which are incorporated herein by reference in its entirety.

### BACKGROUND

Polarization is used to perform a wide range of optical functions including spectral filtering (U.S. Pat. Nos. 7,106,509 and 9,933,636, the contents of each of which are incorporated by reference), optical isolation (US 20190271853, the contents of which are incorporated by reference), and to provide an additional round trip through an optical cavity (e.g., U.S. Pat. No. 6,075,651). Polarization functional components typically consist of two classes: polarizers and retarders. Polarizers work to separate two orthogonal polarizations either by preferentially absorbing one of the components or by physically separating them by reflection or refraction. Retarders act to introduce a phase-difference between orthogonal polarizations.

Typically, polarization-functional components are planar in nature. In most cases this is because the making of such components involves inherently planar processes: casting/extruding and stretching of polymer films along one or more axes, cutting crystalline materials relative to one or more axes, and evaporating multi-layer dielectrics onto a planar surface.

The one ubiquitous application of polarizers in a curved configuration is a polarized sunglass wherein the polarizer is used to diminish the glare from specular reflections. In this application, the absorptive polarizer is thermo-formed into the shape of the curved lens. Because this application does not involve a high degree of polarization and because the user's head is not perfectly stabilized, a polarizer with a high degree of linear polarization is not necessary (i.e., deterioration caused by the thermoforming process may be tolerable).

When working with polymer films (both the retarder films and any supporting substrates) the thermo-forming process necessarily induces deformation and thus additional (non-uniform) retardance. Some efforts have been made to mitigate this effect but they have been limited to managing the “magnitude” of the effect. U.S. Pat. Nos. 8,687,275 and 9,457,523, the contents of each of which are incorporated by reference, describe using either thin materials and/or materials with small stress-optic coefficients when forming curved retarders. U.S. Pat. No. 9,457,523 describes using a highly stretched initial film that is less affected by additional stretching. Both of these solutions are insufficient to enable a general solution.

### SUMMARY

Optical filters of the invention include both optically functional retarder and/or polarizer layers as well as perhaps non-optically functional support substrates and adhesives. Such filters are most conveniently assembled as a laminate structure in planar format lens blank. In order to create a compound-curved lens (e.g., a spherical lens) this blank is then thermo-formed to the desired radius. The thermo-forming step preferentially preserves the magnitude and orientation of the in-plane birefringence. This is accomplished through a forming process that produces a strain that is locally isotropic in the plane of the film everywhere on the lens's surface.

The general forming process includes two sub-processes that may occur in either order or concurrently. The first process deforms the lens blank into a spherical lens while maintaining the outer radius. The strain induced within the lens is largest in the center of the lens and falls approximately quadratically to zero at the perimeter. The second process is an isotropic stretching (or compression) of the lens blank to a new radius. If the second process is performed separately on the curved lens then it corresponds to a change in spherical radius.

In order to create the necessary gradient in strain across the surface of the lens during the first process a temperature gradient may be applied. Where the temperature is higher, the lens blank will deform more due to a constant stress.

An alternative method of creating the strain gradient across the surface of the lens is to apply a stress gradient. Where the stress is higher, the lens blank will deform more at a constant temperature. In order to apply a stress gradient to a lens blank disk, the disk must be placed in physical contact with an additional support structure. This may be a disposable carrier substrate that is temporarily bonded to the blank. Alternatively, the additional material may be a flexible part of the mold apparatus.

Another method of creating the strain gradient is to modify the boundary conditions of the lens blank. The edges of the blank may be clamped in a fixture to force zero net change in radius or alternatively to dilate or contract the lens blank by a specific amount.

### BRIEF DESCRIPTION OF THE DRAWINGS

FIG. 1. Model for thermoforming a disk onto a spherical surface.

FIG. 2. Radial displacement of differential rings resulting from conventional thermoforming.

FIG. 3. In-plane strain components resulting from conventional thermoforming.

FIG. 4. Induced retardance resulting from conventional thermoforming.

FIG. 5. Intensity observed from thermo-formed lens blank between crossed polarizers. Lens blank has zero initial retardance.

FIG. 6. Radial displacement of rings that accomplish isotropic in-plane stretching. Solutions for cases with spherical radius R=4, 5, 10 units where the disk starts with radius 1 unit and ends with cylindrical radius of 1 unit.

FIG. 7. Percent strain as a function of radial position for solutions for cases with spherical radius R=4, 5, 10 units where the disk starts with radius 1 unit and ends with cylindrical radius of 1 unit.

FIG. 8. Retardance induced in thermoformed lens with final spherical radius of 4 units.

FIG. 9. Radial displacement of rings that accomplish isotropic in-plane stretching. Solutions for cases with spherical radius R=4, 5, 10 units where the disk starts with radius 1 unit and ends with cylindrical radius of 1.02 unit.

FIG. 10. Percent strain as a function of radial position for solutions for cases with spherical radius R=4, 5, 10 units where the disk starts with radius 1 unit and ends with cylindrical radius of 1.02 unit.

FIG. 11. Radial displacement of rings that accomplish isotropic in-plane stretching relative to an initial in-plane stretch of 2%. Solutions for cases with spherical radius R=4, 5, 10 units where the disk starts with radius 1 unit and ends with cylindrical radius of 1.02 unit.

FIG. 12. Cross section view of a lens blank within a mold. Ring heaters at different temperatures above blank.

FIG. 13. A) Cross section view of a lens blank within a mold. Lens blank is temporarily bonded to a carrier. B) Lens and carrier after thermoforming.

FIG. 14. A) Cross section view of a lens blank within a mold. Lens blank is temporarily bonded to a carrier placed between lens and mold. B) Lens and carrier after thermoforming.

FIG. 15. A) Cross section view of a lens blank within a mold. Lens blank is temporarily bonded between carriers placed on both sides. B) Lens and carriers after thermoforming.

FIG. 16. A) Cross section view of a lens blank within a mold. Lens blank is temporarily clamped to a rigid frame. B) Lens and frame after thermoforming. Frame increases in diameter.

FIG. 17. Retardation induced in a lens blank during thermoforming when lens is clamped to a rigid frame with fixed radius.

### DETAILED DESCRIPTION

Polarization management is relevant to many consumer products, including computer displays, televisions, mobile phones, camera filters, 3D cinema, virtual-reality and augmented-reality headsets, camera filters, and sunglasses. Polarization management laminates are manufactured in planar form, and in most applications, they are used in that format. However, there are cases in which it is desirable to apply a compound curvature to polarization optics, most notably as required for sunglasses. A planar stack (linear polarizer bonded between substrates) is typically cut into a disk which is then thermoformed into a quasi-spherical patch. A new type of color-enhancing lens based on polarization-interference involves laminating a retarder-stack between linear polarizers (U.S. Pat. No. 9,933,636), followed by thermoforming. There is also a potential to thermoform liquid-crystal devices for the purpose of agile dimmable eyewear.

Recently, it has been noted that optical architectures used in virtual/augmented reality headsets can be improved if compound curved polarization optics can be manufactured (US 20190235145, the contents of which are incorporated by reference). In polarization-based pancake lenses, all-reflective architectures are possible that remove the need for refractive polymer lenses that can create internal residual retardation. It is typically required that the as-laminated performance of a polarization management stack is maintained after the thermoforming process. However, because the process involves heat and mechanical stress, it is more often the case that the performance is compromised, and that changes in behavior become a function of position/angle. This can render the polarization optic useless, and can render an otherwise attractive optical architecture unrealizable.

A retarder (aka phase-difference) film typically includes a polymer material with different indexes of refraction for light polarized in different spatial directions, i.e., birefringent. In the display industry, these are typically composed of polycarbonate, or cyclic-olefin polymer (COP), though other retarder films have been demonstrated. Birefringence is inherent to many materials (non-cubic crystals) but can usually also be induced by the application of stress. The magnitude of the birefringence is equal to the magnitude of the stress multiplied by the stress-optic coefficient. The application of stress also induces strain in the material proportional to the stress multiplied by the elastic modulus. It is therefore possible to derive a strain-optic coefficient by combining the stress-optic coefficient with the elastic modulus (Born, M. and Wolf, E., Principles of Optics, Cambridge, 1980. p. 703-705. ISBN 0 521 63921 2). Birefringence may be permanently induced in a material if the stress induces plastic strain.

The index of refraction of a retarder film can be locally described by its projection upon three principle cartesian coordinates: nₓ, n_{y}, and n_{z}. For simplicity the z-axis is taken to be along the thickness direction of the film. For light normally incident upon a film with one principle dielectric axis parallel to the film normal, the in-plane pathlength difference, Rₑ, is:

Rₑ=(nₓ−n_{y})d #(1)

where d is the thickness of the film. Light that is not normally incident upon the film experiences a pathlength difference due to the third refractive index n_{z}. The magnitude of the impact of this (which depends on the angle of incidence) is characterized by the quantity Rₜₕ:

Rₜₕ=((nₓ+n_{y})/2−n_{z})d #(2)

The retardation is the phase change proportional to the pathlength difference, divided by the wavelength. An a-plate is a retarder for which n_{z}=n_{y}, i.e., a uniaxial retarder in which the principle axis is in the plane of the film. A c-plate is a retarder for which nₓ=n_{y}, i.e., a uniaxial retarder for which the principle axis is parallel to the film normal. Typically, near normal incidence, the performance of retarders is very sensitive to relative changes between the in-plane (nₓ and n_{y}) refractive incidence and much less sensitive to changes relative to n_{z}.

A polarization management stack may contain any of the following: isotropic substrates, linear polarizer films, and one or more retarder films. In the case of laminating stacks of like materials, it may be preferred that a solvent bonding process is used. In the case of bonding dissimilar materials (e.g. triacetyl-cellulose and cyclic-olefin-polymer), an adhesive is typically used that bonds to both polymers and has acceptable optical and mechanical properties. In general, the material system selected must be suitable for the temperatures/durations required to thermoforming the laminate without catastrophic failures (e.g., delamination/bubbles/haze), and physical distortions. It should be possible to make the finished part conformal to a mold in most cases.

The invention recognizes that a polarization management stack typically relies on specific in-plane functionality from each layer. For example, a polarizer may have an absorption axis in-plane with a specific orientation. A retarder may have a slow-axis in-plane with a specific orientation and a specific phase-difference. A substrate may provide mechanical support, with the requirement that it remain isotropic throughout processing. To first order, these are the characteristics that likely determine the behavior of the stack. And in a thermo-forming process that does not consider the impact of stresses, these characteristics are usually degraded, often in a way that is not spatially homogeneous. The invention recognizes the important fact that, while stresses can be induced by the forming process, the impact on in-plane behavior can be mitigated by substantially confining the refractive index change to the thickness direction. That is, an isotropic forming process of the invention may change the refractive index in the thickness direction relative to an opposite and isotropic in-plane change in refractive index. In most cases this would be a slight decrease in refractive index in the thickness direction. In most polarization management scenarios, an incremental C-Plate retardation from isotropic forming has relatively little impact on performance.

The following examples use spherical deformation to illustrate the principles of the invention. However, these principles apply more generally to forming processes that produce any compound-curvature of polymer films. This includes aspherics, toroids, and any situation where a film or laminate is constrained to bend in more than one axis. Some of the principles could also apply to cylindrical (uniaxial) forming of thick films and laminates.

The mechanism for strain-birefringence may be visualized as an increase in the number of molecular bonds oriented relative to the direction of stress. For uniaxial strains, this usually leads to an increase in the index of refraction for light polarized along the direction of strain. The magnitude of the change in index of refraction is proportional to the stress-optic coefficient which may be negative or positive. The increase (or decrease) in index of refraction in one direction is usually accompanied by a corresponding decrease (or increase) in the index of refraction in the orthogonal directions. The stress, strain, stress-optic coefficient, and index of refraction are tensor quantities which depend on the specific materials and geometry used for forming any specific lens. However, the bulk of the behavior may be well approximated by considering the strain components as linearly separate.

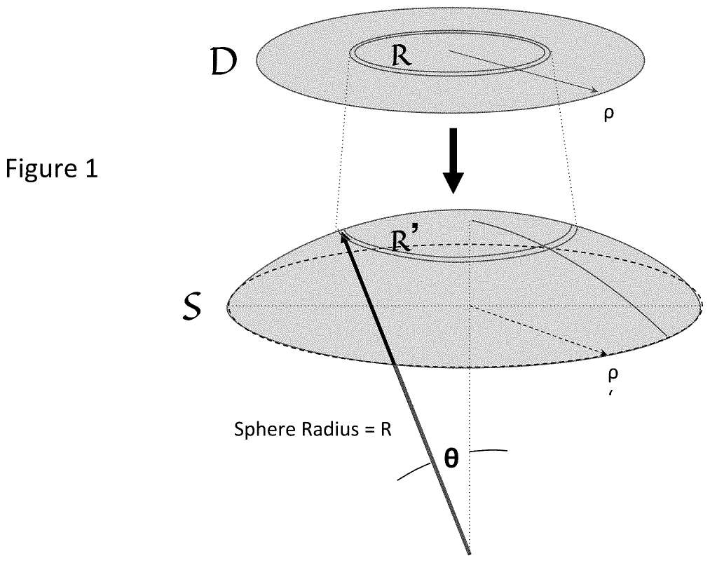

Consider a circular disk, D, of material with starting radius ρ that is formed into a partial spherical shell, S, with spherical radius R as shown in FIG. 1. In transforming D to S, any infinitesimal ring R with starting radius r will be stretched (or compressed) to form a ring R′ with cylindrical radius r′=r+ [symbol] (r). i.e., the change in radius of each ring is a function of its starting radius so that [symbol] (r) describes an arbitrary strain that varies as a function of the radial coordinate. The position of each ring R′ on the spherical surface of S can be described using polar angle θ(r):

$$θ ( r ) = \frac{r + Δ ( r )}{R} \qquad \# ( 3 )$$

S has a final cylindrical radius ρ′=ρ+ [symbol] (ρ). Large positive [symbol] (ρ) is equivalent to large in-plane tensile strain and large negative [symbol] (ρ) corresponds to large compressive in-plane strain.

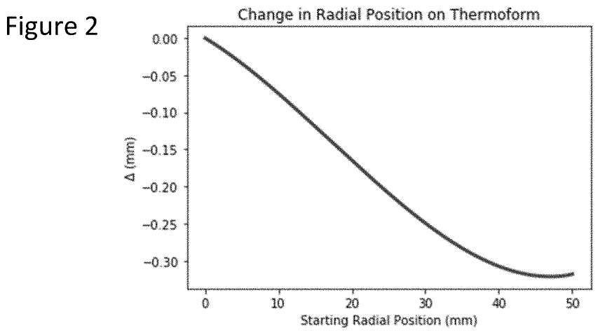

Typical thermoforming of spherical lens components is performed by placing a lens blank into a spherical mold. An air pressure differential is applied across the blank (often by evacuating the mold cavity) so that pressure pushes the mold blank into the mold. Sufficient application of heat and time leads to a permanent plastic deformation. The effect of this process can be modeled using finite element analysis (FEA). FIG. 2 shows a plot of [symbol] (r) computed from an FEA model of a thermoformed disk. In the model, the disk has initial radius ρ=50 mm, thickness 0.5 mm, and Young's modulus of 3150 MPa. The rigid spherical mold has a curvature radius of 200 mm and the upper surface of the disk is subjected to 100 kPa of pressure. These conditions result in a net decrease in the cylindrical radius of the resulting lens: ρ′=ρ*0.994.

Two orthogonal strains may be calculated for each ring. The tangential strain, ϵₜ, is proportional to the change in circumference:

$${ϵ}_{t} = \frac{2 π {r}^{′} - 2 π r}{2 π r} = \frac{Δ ( r )}{r} \qquad \# ( 4 )$$

The radial strain, ϵᵣ, is proportional to the change in the infinitesimal width of ring R:

$${ϵ}_{r} = \frac{R d θ - d r}{d r} \qquad \# ( 5 )$$

and θ may be eliminated to yield:

$${ϵ}_{t} = \frac{1 + \frac{d Δ ( r )}{d r}}{\sqrt{1 - {( \frac{r + Δ ( r )}{R} )}^{2}}} - 1 \qquad \# ( 6 )$$

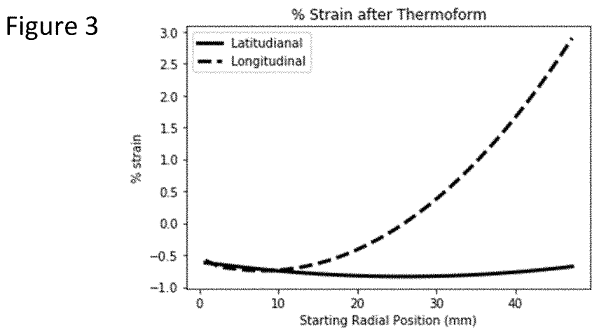

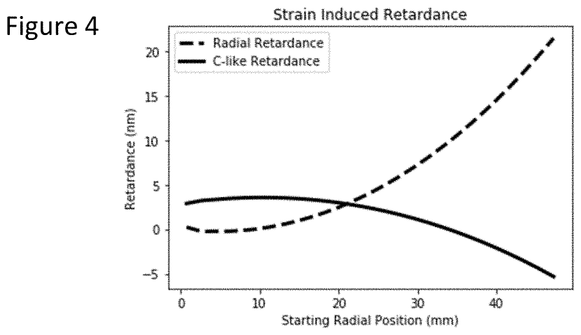

FIG. 3 shows a plot of ϵₜ and ϵᵣ computed from the model results shown in FIG. 2. Near the center of the lens, the two components are equal but the longitudinal (radial) component increases monotonically toward the perimeter whereas the latitudinal (azimuthal) component remains roughly constant. The in-plane retardation can be computed from the difference in in-plane strains multiplied by the strain optic coefficient, K, and film thickness d. Similarly, the c-like retardation may be approximated by assuming a reasonable value for Poisson's ratio (0.4) along with the same K and d. FIG. 4 shows the resulting change in retardation due to the strain plotted in FIG. 3 assuming Kd=600. The in-plane retardation remains low out to a radius of around 10 mm and then rapidly increases to 20 nm. The c-plate retardation starts small and positive and then decreases, eventually becoming negative.

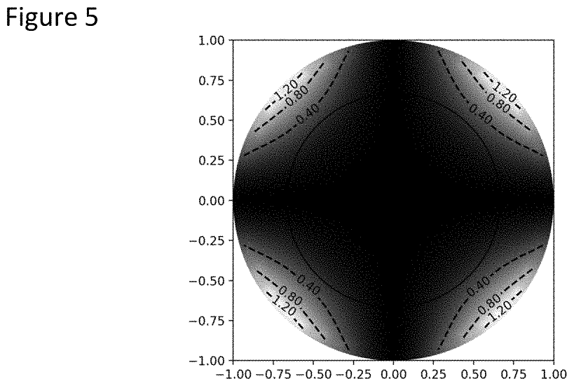

Changes in retardation as shown in FIG. 4 can have a number of effects depending upon where they occur in an optical system. These effects can include a leakage in intensity into a dark state (decrease in contrast between two states) and a gradient in brightness and/or color of the bright state. Furthermore, the effect of the non-uniformity must be considered for every thermoformed component with non-zero stress-optic coefficient including initially isotropic substrates and even adhesives. In order to illustrate the optical effect of the retardance induced by thermoforming, FIG. 5 shows a contour plot of the percent leakage in intensity of an initially isotropic thermoformed disk when placed between crossed polarizers. The change in retardance is taken from the results of FIG. 4. Because the induced retardance is radial, it does not cause leakage when it is oriented parallel to either polarizer. However, along the diagonals of the lens, the leakage increases to 1.2%.

In order to minimize the change in retardance, the strain should be locally isotropic everywhere, i.e.,

ϵₜ=ϵᵣ #(7)

This leads to the following differential equation:

$$\frac{d Δ}{d r} = ( \frac{Δ}{r} + 1 ) \sqrt{1 - {( \frac{r + Δ}{R} )}^{2}} - 1 \qquad \# ( 8 )$$

where the notation has been simplified slightly for clarity ( [symbol] (r)→ [symbol] ). Solving this differential equation for [symbol] yields a strain that is isotropic in the plane of the film.

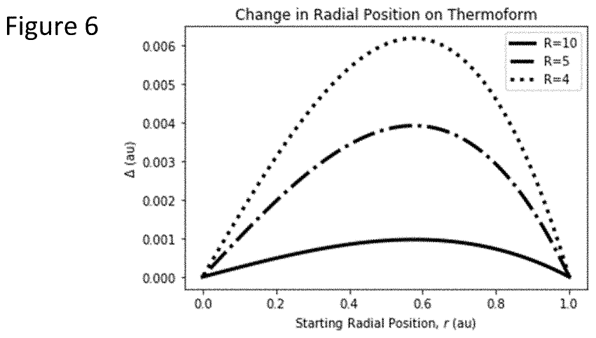

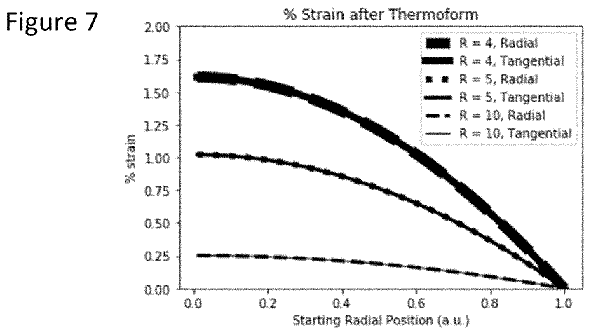

FIG. 6 shows a series of solutions to equation (5) for the condition p=ρ′=1 (for which the boundary condition is [symbol] (ρ=1)=0). The solution is plotted for the cases R=4, 5, 10. As the curvature radius increases, the maximum radial displacement decreases. A more complete picture can be obtained by plugging these results back into equations (3) and (4) and plotting the strain as a function of radial position as shown in FIG. 7. In FIG. 7 the radial and tangential strain values are plotted for each case in order to validate that each solution satisfies equation (5). Interestingly, the magnitude of the strain is always largest in the center of the disk and decreases toward the perimeter. Additionally, the shapes of the curve are nearly identical apart from a scale factor. In fact, the curves shown in FIG. 3 may be fit approximately to a parabola.

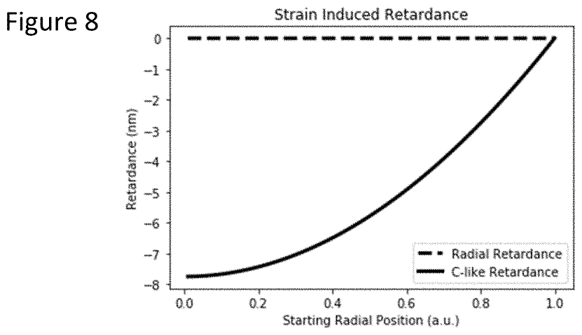

FIG. 8 shows the retardation induced due to the strains shown in FIG. 5 for the most highly curved filter (R=4). The additional in-plane retardation is zero everywhere. The c-plate retardation is highest in the center of the lens and drops to zero at the perimeter where the total strain is zero. Because the in-plane retardation is zero, the leakage between crossed polarizers is also zero across the entire lens. In order to observe the effect of induced c-plate retardance, the sample must be illuminated with off-normal light. For a 30 degree uniform cone of illumination, the leakage increases by less than 0.01% in the center of the lens.

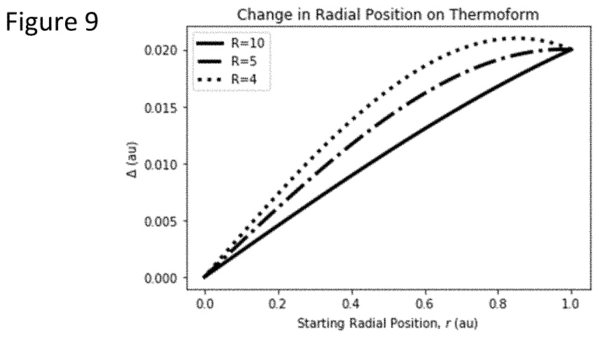

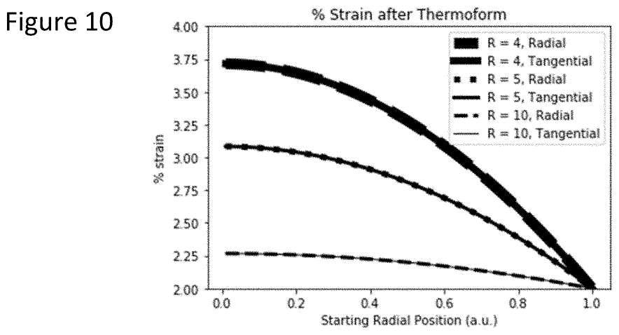

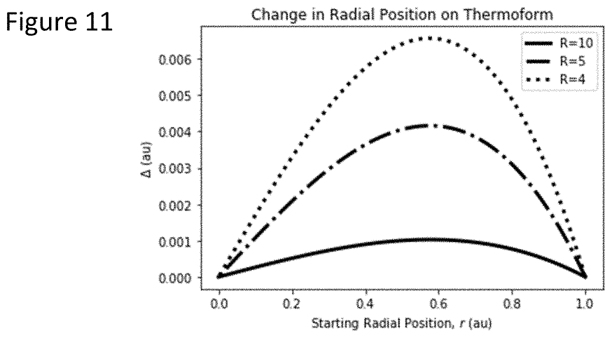

In general, the outer boundary need not be fixed. FIG. 9 shows a series of solutions to equation (5) for the condition ρ′=1.02*ρ (for which the boundary condition is [symbol] (ρ=1)=0.02). This is a lens in which the outer cylindrical radius has been stretched by 2%. FIG. 10 shows the corresponding plots for the radial and tangential strain. The strains are again approximately parabolic with respect to the radial coordinate and are nearly identical to the strains plotted in FIG. 3 apart from an offset of 2%. The 2% offset is identical to the stretching at the perimeter due to the new boundary condition. FIG. 11 shows a plot of the quantity [symbol] (r)−r*1.02 for the solutions shown in FIGS. 6 and 7. The quantity r*1.02 subtracts off the effect due to the radial stretching. The difference between FIG. 11 and FIG. 6 is due to the slight change in radii between the two simulations: the second simulation would scale exactly to the first simulation if the radii, R, were also scaled by 2%. This shows that a change in the cylindrical radius of the lens may be modeled as two separate processes: 1) isotropically stretching (or compressing) the disk to a new radius and then 2) forming the disk into a spherical lens. Step 1 preserves in-plane birefringence, so as long as step 2 satisfies equation (5), the final lens will have isotropic in-plane stretching. These processes may be performed in any order or simultaneously.

Inspection of FIG. 6 shows that the condition for isotropic in-plane forming requires that the film experiences largest strain in the center with the amount of strain falling approximately quadratically to zero at the perimeter. This can be contrasted with a typical method for forming a lens from a flat disk: the flat disk is placed into a spherical mold where it is heated and then pressure is used to force the disk to conform to the shape of the mold. During this process, the entire lens blank is under tension so that to the extent that temperature is uniform, the entire disk can be expected to undergo relatively uniform (though not necessarily isotropic) strain. In practice, the mold will transfer more heat to the perimeter of the lens blank where contact is first made and so the edges will likely experience *more* strain than the center.

As mentioned above, one consequence of generating isotropic in-plane strain is that the final lens must develop some amount of C-plate-like retardance. C-plate retardance typically refers to phase difference associated with an increase in in-plane refractive index relative to that in the thickness (or normal) direction. The tensile strain shown in FIGS. 6 and 9 would lead to a relative drop in the index of refraction for light polarized parallel to the surface normal (negative c-plate for positive strain-optic coefficient). The magnitude of the change in index of refraction would then decrease toward the perimeter becoming zero for the lens in FIG. 6 and finite for the lens in FIG. 9.

The preceding discussion addresses the requirements for achieving ideal performance where equation (#7) holds precisely. However, in many cases it may be sufficient to merely improve over the results obtained when the relative magnitudes of the in-plane strain are unconstrained. The magnitude of the induced retardance depends upon the thickness of the functional and non-functional layers as well as the magnitude of the stress optic coefficient. For example, FIGS. 3 and 4 show an example of unconstrained thermoforming in which a radial retardance of 20 nm is produced near the edges of the lens. In order to improve the performance, the radial retardance could be diminished by reducing the strain at the perimeter of the lens and increasing it in the center of the lens.

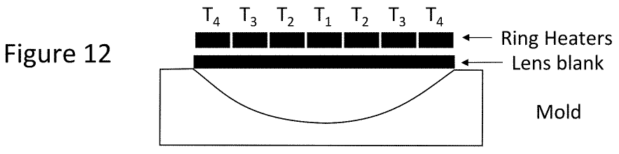

In order to achieve an optimal gradient in strain, either the temperature or the applied stress should be non-uniform. The rate of plastic deformation is proportional to temperature. Therefore, if the temperature is higher in the middle of the disk, then that region will experience the largest strain. This can be accomplished partially by (e.g.) directing a heated jet of air toward the middle of the disk. A more controlled method would be to separately temperature control heating rings above the disk. FIG. 12 shows a cross section of such a segmented heater with 4 temperature zones in which T₁>T₂>T₃>T₄. The precise width of each zone and temperature profile depends on the yield strain rate for the specific lens blank being formed.

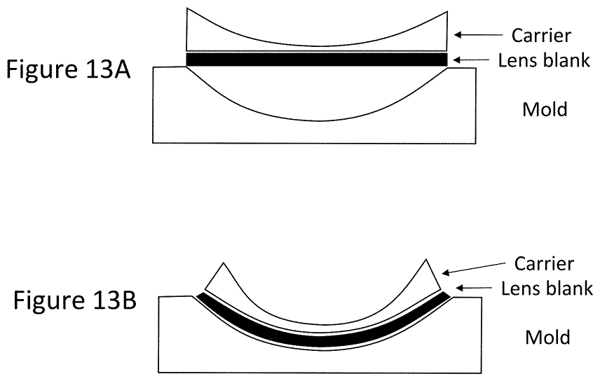

An alternative method of achieving a gradient in strain is by mechanically constraining the lens blank. FIG. 13A shows a cross section of a lens blank that is temporarily attached to a carrier. The thickness of the carrier increases toward the perimeter and thus provides a corresponding increase in resistance to strain. FIG. 13B shows the assembly after thermoforming. The attachment may be made using a removable adhesive such as a UV cross-linkable PSA. In some cases, friction may provide a sufficient bond between the carrier: for example, silicone elastomer may have sufficiently high coefficient of friction in contact with another clean surface.

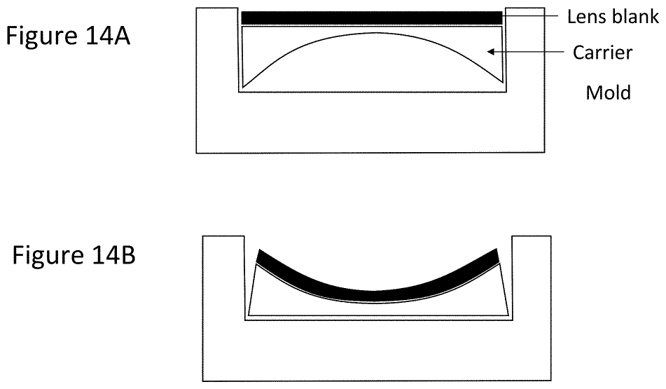

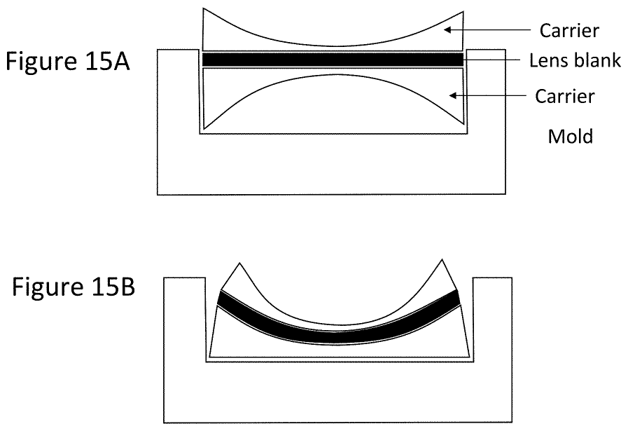

FIGS. 14 A and B shows a cross section of a lens blank temporarily bonded to a carrier where the carrier is between the blank and the mold. In this configuration the shape of the lens blank is critical because it determines the shape of the final lens in addition to providing spatially varying strain resistance. The advantage of this configuration is that it applies compressive in-plane stress during the forming process. FIG. 15 shows a cross section of a lens blank with carriers bonded both above and below the lens.

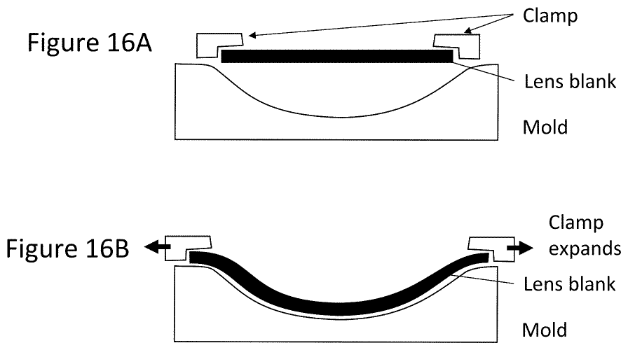

Modification of the strain during thermoforming may also be accomplished by adjusting the boundary conditions of the film blank. In conventional thermoforming the lens blank is typically placed into the mold and the perimeter is free to shrink by sliding on the surface of the mold. FIG. 16 A shows a cross section of a mold in which the lens blank is clamped. During forming, this clamp may be rigidly held, radially dilated as shown in FIG. 16B, or controllably contracted.

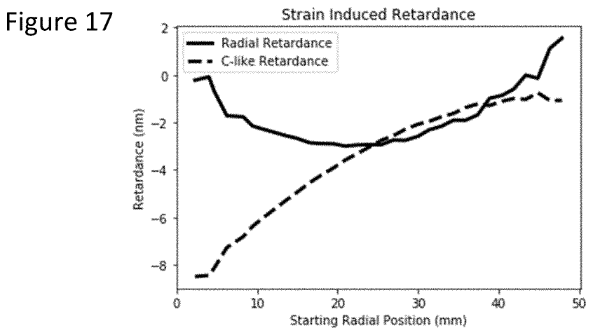

FIG. 17 shows the retardation computed in a disk that has been rigidly fixed at its perimeter and then pressed into a mold. In this case the maximum induced retardation is a factor of 4 smaller than retardation that was induced in the disk that is free to move in the mold. Additionally, the peak in retardation occurs at approximately half the radius rather than at the perimeter. The corresponding c-like retardation has a maximum in the center of the lens and drops monotonically toward the perimeter.

For purposes herein, a diopter is equal to 530 divided by the radius of curvature of an optical element in mm.

The invention claimed is:

1. An optical element, comprising:
a polymer substrate thermoformed to form a compound curved surface with isotropic in-plane strain, wherein the local in-plane pathlength difference (Rₑ) is constant across the lens.

2. An optical element as defined in claim 1 wherein the magnitude of in-plane strain decreases approximately quadratically from the center to the edge of the optical element.

3. An optical element as defined in claim 1, wherein the magnitude of Rₜₕ increases from the center of the optical element to the edge of the optical element.

4. An optical element as defined in claim 1, wherein the optical element is spherical.

5. An optical element as defined in claim 1, wherein the polymer substrate includes a PVA polarizer between isotropic substrates.

6. An optical element as defined in claim 1 wherein the polymer substrate includes a PVA polarizer between stretched polycarbonate layers.

7. An optical element as defined in claim 1 wherein the substrate includes a polycarbonate or cyclic-olefin stretched polymer retarder.

8. An optical element as defined in claim 4 wherein the substrate includes a laminate of two or more stretched polymer retarder films.

9. An optical element as defined in claim 5 wherein the laminate is solvent bonded.

10. An optical element as defined in claim 1 wherein the final base curve is between 1 and 10 diopters.

11. An optical element as defined in claim 1 wherein the formed optical element is one of spherical, aspheric, or toroidal compound curvature.

12. An optical element as defined in claim 1 wherein the polymer substrate is a polarizer adhesively bonded to one or more solvent-bonded retarder films.

13. A method to produce a lens, the method comprising:
thermoforming a lens blank in a mold to form a curved surface, using a temperature gradient applied across a surface of the lens with radiative heaters to direct more heat energy to a center of the lens than to an edge of the lens, to heat the center of the lens to a higher temperature than the edge of the lens; and
wherein the mold provides a temperature gradient to the edge of lens to cool the edge.

14. A method as defined in claim 13 wherein the local in-plane pathlength difference (Rₑ) is constant across the lens.

15. A method as defined in claim 13 wherein the magnitude of in-plane strain decreases approximately quadratically from the center to the edge of the optical element.

16. A method as defined in claim 13, wherein the magnitude of Rₜₕ increases from the center of the optical element to the edge of the optical element.

17. A method as defined in claim 13, wherein the lens is a spherical lens.

18. A method to produce a lens, the method comprising:
thermoforming a lens blank in a mold to form a curved surface, with a carrier substrate bonded to the lens blank;
wherein the carrier is thinner in a center thereof and thicker on a perimeter thereof;

19. A method as defined in claim 18 wherein the local in-plane pathlength difference (Rₑ) is constant across the lens.

20. A method as defined in claim 18 wherein the magnitude of in-plane strain decreases approximately quadratically from the center to the edge of the optical element.

21. A method as defined in claim 18, wherein the magnitude of Rₜₕ increases from the center of the optical element to the edge of the optical element.

22. A method as defined in claim 18, wherein the lens is a spherical lens.

23. A method as defined in claim 18, wherein the carrier is removed after the thermo-forming process.

24. A method as defined in claim 18, wherein the carrier has a low stress-optic coefficient and is incorporated into the final lens.

25. A method as defined in claim 18, wherein the carrier is external to any analyzing polarizers and is incorporated into the final lens.

26. A method to form a lens, the method comprising:
thermoforming a lens blank in a mold to form a curved surface;
wherein the lens is rigidly clamped while thermoforming to maintain a fixed lens diameter.

27. A method as defined in claim 26 wherein the local in-plane pathlength difference (Rₑ) is constant across the lens.

28. A method as defined in claim 26 wherein the magnitude of in-plane strain decreases approximately quadratically from the center to the edge of the optical element.

29. A method as defined in claim 26, wherein the magnitude of Rₜₕ increases from the center of the optical element to the edge of the optical element.

30. A method as defined in claim 26, wherein the lens is a spherical lens.
